(19) United States
(12) Patent Application Publication
(10) Pub. No.: US 2003/0025254 A1
(43) Pub. Date: Feb. 6, 2003

(54) Spring assembly having bands of springs

(75) Inventor: Joe C. Workman, Carthage, MO (US)

Correspondence Address: J. Dwight Poffenberger, Jr., Wood, Herron & Evans, L.L.P., 2700 Carew Tower, 441 Vine Street, Cincinnati, OH, 45202-2917, US

(73) Assignee: L&P Property Management Company, South Gate, CA (US)

(21) Appl. No.: 09/923,040

(22) Filed: Aug. 6, 2001

(51) Int. Cl. F16F 3/04

(52) U.S. Cl. 267/91; 267/80

(57) ABSTRACT

A coil spring assembly for use in the manufacture of bedding and seating products or the like comprising a plurality of bands of coil springs joined together with helical lacing wires. Each of the bands of coil springs is made of one piece of wire formed into a row of coil springs. The helical lacing wires are spaced inwardly from the end turns of the coil springs, thereby creating a cushioning affect on at least one surface of the product.

### FIELD OF THE INVENTION

This invention relates to spring assemblies for mattresses, cushions and the like and, more particularly, to spring assemblies formed by joining multiple rows of interconnected springs.

### BACKGROUND OF THE INVENTION

Traditionally, a spring core for a mattress comprises a plurality of aligned coil springs, each coil spring having an upper end turn and a lower end turn interconnected by one or more turns, revolutions or central convolutions of the spring. All of the coil springs are of approximately identical height so that all of the upper end turns lie in a common top plane and, similarly, all of the lower end turns lie in a common bottom plane. The spring core typically has a longitudinal dimension and a transverse dimension, the longitudinal dimension being greater than the transverse dimension. However, the longitudinal and transverse dimensions may be identical in a square product.

The coil springs are aligned in longitudinally extending columns and transversely extending rows. The coils springs are typically joined by helical lacing wires located in the top and bottom planes of the spring core which encircle the end turns of adjacent rows or columns of coil springs, depending upon the orientation of the helical lacing wires. Thus, the helical lacing wires may extend either transversely connecting adjacent rows of individual coil springs or longitudinally connecting adjacent columns of coil springs. Often, a pair of rectangular border wires are located in the top and bottom planes of the spring core and the outermost coil springs clipped or otherwise secured to the border wires.

Alternatively, a mattress spring core may be formed with bands of springs rather than individual coil springs. Each of these bands of springs is formed of a single piece or length of wire formed into a plurality of connected coil springs, each coil spring having an upper end turn, a lower end turn and a plurality of central convolutions therebetween. Adjacent bands of coil springs are joined by helical lacing wires. Typically, these continuous bands of springs extend longitudinally and the helical lacing wires extend transversely of the bands and embrace portions of the bands.

Several different kinds of bands of springs have been proposed for incorporation into spring interiors of bedding mattresses. One kind of band which is the subject of British Patent No. 2,143,731 will hereinafter be referred to as a band of interlocked or interlaced springs. In addition, U.S. Pat. Nos. 4,053,956 and 4,112,726 disclose bands of springs made of a single length of wire without the convolutions of the coil springs being interlocked or interlaced. In either case, such a band comprises a single length of wire configured to form a plurality of individual coil springs arranged in a row, one end turn of each coil spring lying adjacent to a top face of the band and the other end turn of the coil spring lying adjacent to a bottom face of the band. Each coil spring is of a rotational hand either opposite to or of the same rotational hand of the adjacent coils immediately before it in the row. Each coil spring is joined to the adjacent coil springs by a plurality of interconnecting segments of wire integral with the coil springs. One of the pair of interconnecting segments is located in the bottom face of the band and the other of the pair of interconnecting segments is located in the top face of the band.

Regardless of whether a mattress spring core is made of a plurality of aligned individual coil springs or a plurality of bands of coil springs, the end turns of the coil springs must be connected together in order to maintain the alignment of the coil springs in the spring core. Helical lacing wires, clips, or hog rings are the most common forms of connectors used to connect adjacent end turns of adjacent rows or columns of coil springs.

It is known to connect adjacent bands of springs with helical lacing wires, the lacing wires encircling the upper and lower end turns of the coil springs of the bands. For example, in applicant's U.S. Pat. No. 5,649,332, transversely extending helical lacing wires connect multiple longitudinally extending bands of springs by encircling the upper and lower end turns of the coil springs of the bands. One consequence of such construction is that the upper and lower surfaces of the spring assembly have a relatively “hard” or rigid feel due to the presence of the helical lacing wires in the top and bottom planes of the spring assembly.

U.S. Pat. No. 5,713,088 discloses a spring assembly comprising a plurality of individual coil springs joined together by helical lacing wires. The central convolutions of the coil springs disclosed in this patent have offset segments which are overlapped and captured within the helical lacing wires between the upper and lower end turns of the coil springs. Such coil springs are expensive to manufacture and increase the cost of the resulting spring assembly. In addition, a special machine is required to apply the helical lacing wires.

Therefore, it has been one objective of the present invention to provide a spring assembly made of multiple bands of springs joined together with helical lacing wires spaced below the upper end turns of the coil springs of the bands, thereby creating a “soft” topper effect.

It has been another objective of the invention to join together a plurality of bands of springs into a spring assembly by encircling internal convolutions of the coil springs of the bands with helical lacing wires between the end turns of the coil springs.

### SUMMARY OF THE INVENTION

The invention of this application which accomplishes these objectives comprises a spring assembly made of a plurality of bands of springs joined together with helical lacing wires. Each band of springs is formed from a single length of wire formed into a row of interconnected coil springs. Each of the coil springs has an upper, lower end turn and central convolutions located therebetween. The central convolutions of the coil spring define a vertically oriented spring axis. Each of the coil springs is connected to adjacent coil springs by interconnecting segments of wire located alternatively in top and bottom faces of the band.

Adjacent bands of coil springs are joined with helical lacing wires, commonly known in the industry as “helicals.” The helical lacing wires are located between the top and bottom faces of the bands. In one embodiment of the present invention, a first set of helical lacing wires encircle the central convolutions of the coil springs of adjacent bands below the upper end turns of the coil springs. A second set of helical lacing wires encircle the lower end turns of the coil springs of the bands. In this embodiment only the top surface of the product has a relatively “soft” feel due to the “free floating” upper end portions of the coil springs of the bands above the helical lacing wires. The lower surface of the product has a relatively “hard” feel due to the presence of the second set of helical lacing wires in the bottom plane of the product.

In an alternative embodiment of the present invention, a first set of helical lacing wires encircle the central convolutions of the coil springs of adjacent bands below the upper end turns of the coil springs. A second set of helical lacing wires encircle the central convolutions of the coil springs of adjacent bands above the lower end turns of the coil springs of the bands. Thus, in this embodiment both the top and bottom surfaces of the product have relatively “soft” feel due to the “free floating” end portions of the coil springs of the bands located above and below the helical lacing wires.

These and other objects and advantages of the invention of this application will become more readily apparent from the following description of the drawings.

### BRIEF DESCRIPTION OF THE DRAWINGS

FIG. 1 is a perspective view of a bedding or seating product incorporating one embodiment of the spring assembly of the present invention;

FIG. 1A is an enlarged perspective view of a portion of the spring assembly of FIG. 1;

FIG. 2 is a side elevational view partially broken away of a portion of the product of FIG. 1;

FIG. 3 is an end view partially broken away of a portion of the product of FIG. 1;

FIG. 4 is a cross-sectional view of a portion of a bedding or seating product incorporating an alternative embodiment of spring assembly;

FIG. 5 is an end view like FIG. 3 of the product of FIG. 4;

FIG. 6 is a top view, partially cut away, of the product of FIG. 1; and

FIG. 7 is a top view, partially cut away, of an alternative embodiment of the present invention.

### DETAILED DESCRIPTION OF THE DRAWINGS

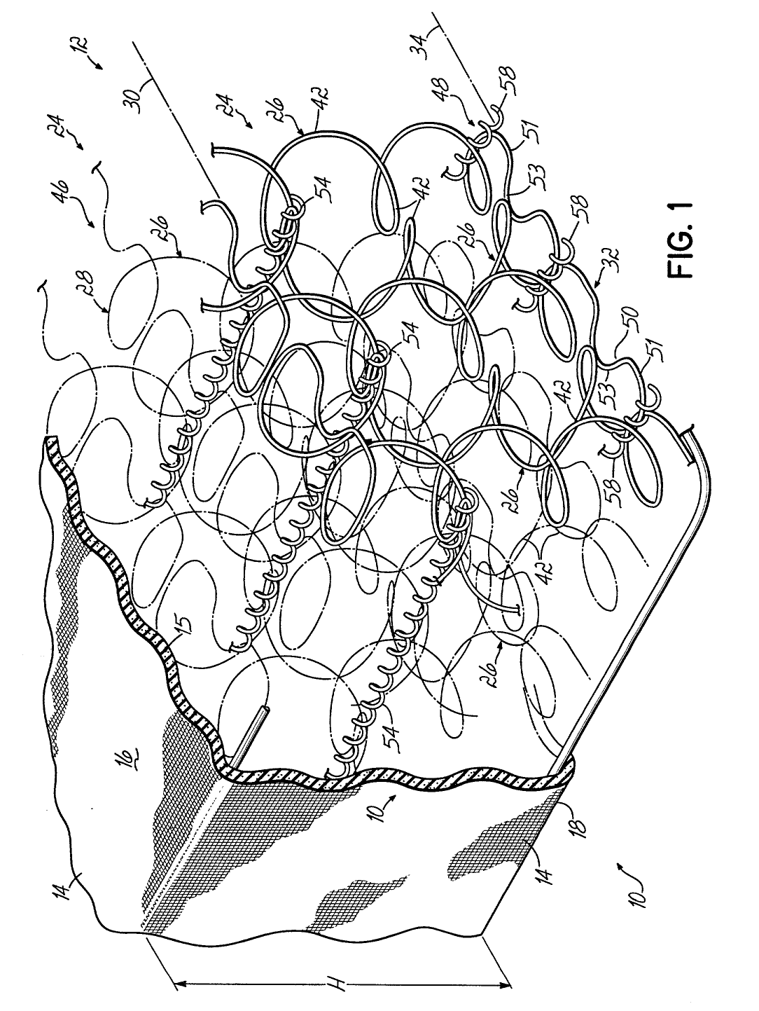

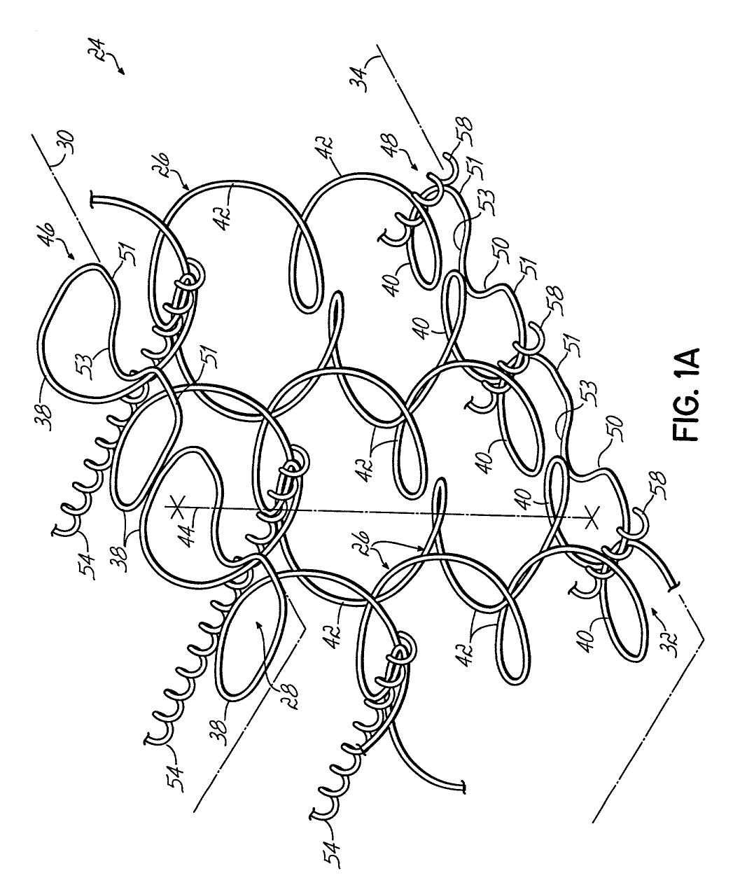

Referring to the drawings, and particularly to FIG. 1, there is illustrated a bedding or seating product 10. The bedding or seating product 10 comprises a spring assembly 12 encased in a fabric covering 14. In addition, one or more pads 15 may be placed on top or below the spring assembly 12, inside the fabric covering 14.

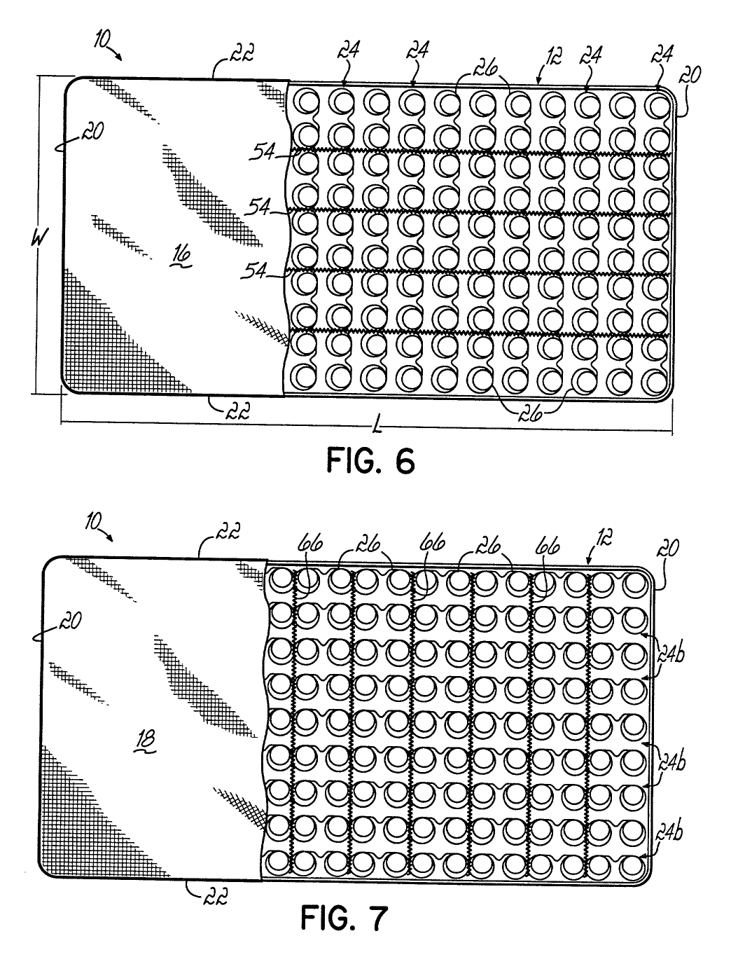

As best illustrated in FIGS. 1 and 6, the product 10 has a top surface 16, a bottom surface 18, a pair of opposed end surfaces 20 and a pair of opposed side surfaces 22. The linear distance between the side surfaces 20 defines the width W or transverse dimension of the product 10. The linear distance between the end surfaces 20 defines the length or longitudinal dimension L of the product. As best seen in FIG. 1, the vertical distance between the top and bottom surfaces 16,18 defines the height H of the product. Typically the longitudinal dimension L is greater than the transverse dimension W of the product. However, the present application intends to additionally cover square products in which the longitudinal and transverse dimensions are identical.

Referring to FIGS. 1 and 1A, the spring assembly 12 comprises a plurality of transversely extending bands 24 of coil springs 26. The spring assembly 12 has a generally planar upper surface 28 located in a generally horizontal top plane 30 and a generally planar lower surface 32 located in a generally horizontal bottom plane 34.

As best illustrated in FIG. 1A, each band 24 of coil springs 26 comprises a plurality of interlaced aligned coil springs 26 made of a single length or piece of wire, the coil springs 26 being arranged in a row. Each coil spring 26 has an upper end turn 38, lower end turn 40 and a plurality of central convolutions 42 located between the upper and lower end turns. The central convolutions 42 of each coil spring 26 define a coil spring axis 44. The band 24 of coil springs 26 has a top face 46 and a bottom face 48, the upper end turns 38 being located in the top face 46 of the band 24 and the lower end turns 40 being located in the bottom face 48 of the band (see FIG. 1A). Adjacent end turns are connected by interconnecting segments 50 located in the top and bottom faces 46,48 of the band (see FIG. 1A). Each interconnecting segment 50 includes end portions 51 between which is a nose 53. A more complete description of the band of springs 24 may be found in U.S. Pat. No. 5,127,635, the disclosure of which is hereby fully incorporated by reference. Although one configuration of band of springs is illustrated and described, other configurations may be used in accordance with the present invention.

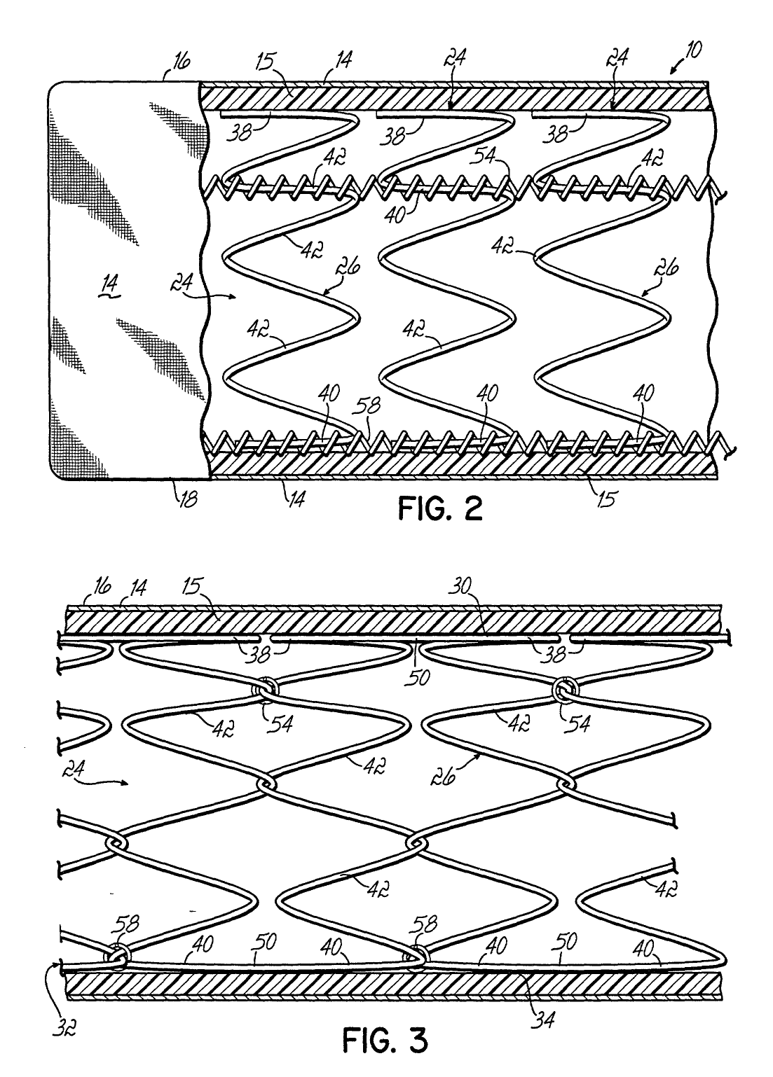

As illustrated in FIGS. 1, 1A, 2 and 3, one embodiment of the present invention utilizes a first set of helical lacings wires 54, referred to in this application as upper helical lacing wires, to secure adjacent bands of springs together. In this embodiment of the present invention, the upper helical lacing wires 54 are spaced downwardly from the upper end turns 38 of the coil springs 26 approximately one turn or convolution. As best illustrated in FIGS. 2 and 3, each upper helical lacing wire 54 encircles and captures one of the central convolutions 42 of each of two adjacent coil springs 26 within the same band 24. The spacing between the upper surface 28 of the spring assembly 12 and the first set of helical lacing wires 54 creates a topper effect or a cushioning sensation when a person lies upon the product. This effect creates a softer feel on the upper surface of the product of the present invention as compared to products heretofore known in which the helical lacing wires connect the upper end turns of the coil springs of adjacent bands.

Although the upper helical lacing wires 54 are located downwardly from the upper end turns of the coil springs approximately one convolution, they may be located anywhere along the length of the coil springs 26 such as, for example, two convolutions from the upper end turns of the coil springs. The greater the vertical distance between the upper helical lacing wires 54 and the upper surface of the spring assembly 12, the greater the cushioning or topper effect.

As illustrated in FIGS. 2 and 3, a second set of helical lacing wires 58, referred to in this application as lower helical lacing wires, connect the lower end turns 40 of adjacent coil springs 26 within a band 24. As illustrated in FIG. 3, the lower helical lacing wires 58 encircle the lower end turns 40 of adjacent coil springs 26 in the lower surface 32 of the spring assembly 12. Locating the second set of helical lacing wires 58 in the lower surface 32 of the spring assembly 12 creates a relatively “hard” lower surface which does not have the same cushioning or “topper” effect as the upper surface of the product. Thus, this type of product is referred to in the industry as a one-sided product, the upper surface being “softer” than the lower surface of the product.

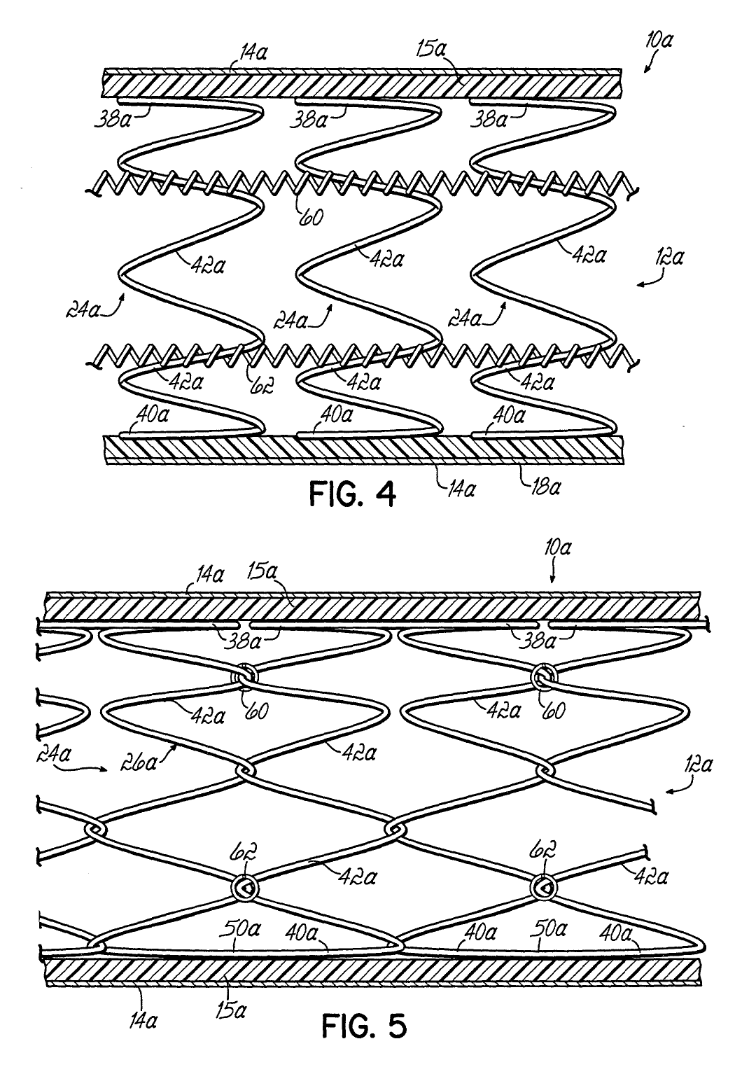

FIGS. 4 and 5 illustrate an alternative embodiment of the present invention. In this alternative embodiment of the present invention, a bedding or seating product 10a has a pair of pads 15a and a spring assembly 12a therebetween, all encased in a fabric covering 14a. The spring assembly 12a comprises a plurality of bands of coil springs 24a of coil springs 26a. Adjacent bands 24a of coil springs 26a are connected with upper helical lacing wires 60 and lower helical lacing wires 62. As best illustrated in FIG. 5, the upper helical lacing wires 60 encircle the central convolutions 42a of adjacent coil springs 26a downwardly one convolution from the upper end turns 38a of the coil springs. Similarly, the lower helical lacing wires 62 encircle the central convolutions of adjacent coil springs 26a upwardly approximately one convolution from the lower end turns 40a of the coil springs 26a.

Due to the inward spacing of the upper and lower helical lacing wires, this product 10a has a topper effect on both the upper and lower surfaces of the product. Therefore, product 10a is referred to in the industry as a two-sided product, and may be used interchangeably on either side.

FIG. 7 illustrates an alternative embodiment of the present invention in which bands of coil springs 24b extend longitudinally, and the helical lacing wires 66 extend transversely. Thus, regardless of whether the bands of coil springs extend transversely or longitudinally, the longitudinal direction of the bands of coil springs is generally perpendicular to the direction of elongation of the helical lacing wires.

Regardless of whether the embodiment illustrated in FIGS. 2 and 3 of this application or the embodiment illustrated in FIGS. 4 and 5 is utilized, the helical lacing wires may extend longitudinally as illustrated in FIG. 6 or transversely as illustrated in FIG. 7. Regardless of whether a one-sided product or a two-sided product in accordance with the present invention is utilized, the helical lacing wires may be oriented longitudinally as illustrated in FIG. 6 or transversely as illustrated in FIG. 7, depending upon the effect desired.

While I have described several embodiments of the present invention, persons skilled in the art will appreciate changes and modifications which may be made without departing from the spirit of the invention. Therefore, I do not intend to be limited except by the scope of the following claims.

What is claimed is:

1. A spring assembly for use in the manufacture of bedding and seating products, said spring assembly comprising:
a plurality of bands of springs joined together, each of said bands of springs being formed from a single length of wire formed into a plurality of coil springs, each of said coil springs having an upper end turn, a lower end turn and a plurality of central convolutions between said upper and lower end turns, said coil springs of said band being arranged in a row and innerconnected by interconnecting segments of wire located alternatively in top and bottom faces of the band, adjacent bands being held together with helical lacing wires located between said top and bottom faces of said bands.

2. The spring assembly of claim 1 wherein said central convolutions of said coil spring define a spring axis.

3. The spring assembly of claim 1 wherein said bands are oriented longitudinally.

4. The spring assembly of claim 1 wherein said bands are oriented transversely.

5. A spring assembly for use in the manufacture of bedding and seating products, said spring assembly comprising:
a plurality of bands of springs joined together by helical lacing wires, each of said bands of springs being formed from a single length of wire formed into a plurality of coil springs, each of said coil springs having an upper end turn, a lower end turn and a plurality of central convolutions between said upper and lower end turns, said coil springs of said band being arranged in a row and innerconnected by interconnecting segments of wire located alternatively in top and bottom faces of the band, said helical lacing wires encircling said central convolutions of said coil springs.

6. The pocketed spring assembly of claim 5 wherein said helical lacing wires are spaced below said upper end turns of said coil springs.

7. The pocketed spring assembly of claim 5 wherein said helical lacing wires are spaced above said lower end turns of said coil springs.

8. A spring assembly for use in the manufacture of bedding and seating products, said spring assembly comprising:
a plurality of bands of springs joined together by first and second sets of helical lacing wires, each of said bands of springs being formed from a single length of wire formed into a plurality of coil springs, each of said coil springs having an upper end turn, a lower end turn and a plurality of central convolutions between said upper and lower end turns, said coil springs of said band being arranged in a row and innerconnected by interconnecting segments of wire located alternatively in top and bottom faces of the band, said first set of helical lacing wires encircling said central convolutions of said coil springs below said upper end turns of said coil springs and said second set of helical lacing wires encircling said central convolutions of said coil springs above said lower end turns of said coil springs.

9. A spring assembly for use in the manufacture of bedding and seating products, said spring assembly comprising:
a plurality of bands of springs joined together by first and second sets of helical lacing wires, each of said bands of springs being formed from a single length of wire formed into a plurality of coil springs, each of said coil springs having an upper end turn, a lower end turn and a plurality of central convolutions between said upper and lower end turns, said coil springs of said band being arranged in a row and innerconnected by interconnecting segments of wire located alternatively in top and bottom faces of the band, said first set of helical lacing wires encircling said central convolutions of said coil springs below said upper end turns of said coil springs and said second set of helical lacing wires encircling said lower end turns of said coil springs.

10. A method of making a spring assembly, said spring assembly having a longitudinal dimension and a transverse dimension, said longitudinal dimension being greater than said transverse dimension, said spring assembly comprising a plurality of bands of springs, each of said bands of springs being formed from a single length of wire formed into a plurality of coil springs, each of said coil springs having an upper end turn, a lower end turn and a plurality of central convolutions between said upper and lower end turns, said coil springs of said band being arranged in a row and innerconnected by interconnecting segments of wire located alternatively in top and bottom faces of the band, said method comprising the steps of:
aligning a plurality of said bands of springs, and
encircling select central convolutions said coil springs of adjacent bands of springs with helical lacing wires.
